(19) United States
(12) Patent Application Publication
(10) Pub. No.: US 2026/0030983 A1
(43) Pub. Date: Jan. 29, 2026

(54) WARNING METHOD AND APPARATUS, AND INTELLIGENT DRIVING DEVICE

(71) Applicant: Shenzhen Yinwang Intelligent Technologies Co., Ltd., Shenzhen (CN)

(72) Inventors: Zixi Nie, Dongguan (CN); Renxie Zhang, Shanghai (CN); Baohang Zhu, Shenzhen (CN); Dongdong Chen, Shanghai (CN); Renjie Qi, Shanghai (CN)

(73) Assignee: Shenzhen Yinwang Intelligent Technologies Co., Ltd., Shenzhen (CN)

(21) Appl. No.: 19/343,352

(22) Filed: Sep. 29, 2025

Related U.S. Application Data
(63) Continuation of application No. PCT/CN2024/080301, filed on Mar. 6, 2024.

(30) Foreign Application Priority Data
Mar. 29, 2023 (CN) 202310355602.8

(51) Int. Cl. G08G 1/0967

(52) U.S. Cl. CPC G08G 1/0967

(57) ABSTRACT

A method includes: obtaining, with a sensor of an intelligent driving device, information about a speed limit sign, where the information about the speed limit sign indicates that the speed limit sign is a ramp speed limit sign or an auxiliary road speed limit sign. The method includes determining, based on road information of a first lane on which the intelligent driving device is located and the information about the speed limit sign, whether to alert a user to a speed limit value corresponding to the speed limit sign. The road information of the first lane indicates that the first lane is a main road, a ramp, or an auxiliary road. The method alerts the user to the speed limit value corresponding to the speed limit sign.

### CROSS-REFERENCE TO RELATED APPLICATIONS

This application is a continuation of International Application No. PCT/CN2024/080301, filed on Mar. 6, 2024, which claims priority to Chinese Patent Application No. 202310355602.8, filed on Mar. 29, 2023. The disclosures of the aforementioned applications are hereby incorporated by reference in their entireties.

### TECHNICAL FIELD

Embodiments of this application relate to the field of intelligent vehicles, and more specifically, to a warning method and apparatus, and an intelligent driving device.

### BACKGROUND

As intelligent vehicles are widely used in daily life, users expect that the intelligent vehicles can bring more comfortable intelligent experience. In this context, a traffic sign recognition driver assistance function (traffic sign recognition system, TSR) has emerged. The TSR may use a camera to recognize a common traffic sign, to alert drivers to a speed limit change, and protect driving safety of the users to a large extent.

However, in an actual application process of the TSR, when the vehicle is in a complex scenario (for example, a ramp, or urban main and auxiliary roads), the vehicle is prone to recognize a speed limit that does not belong to a current lane, resulting in speed limit mis-selection and reduction in accuracy of speed limit recognition.

### SUMMARY

Embodiments of this application provide a warning method and apparatus, and an intelligent driving device, to avoid a case in which the intelligent driving device incorrectly selects a speed limit in a complex scenario, and improve accuracy of recognizing a speed limit value by the intelligent driving device.

According to an aspect of the present disclosure, a warning method is provided. The method includes: obtaining information about a speed limit sign, where the information about the speed limit sign indicates that the speed limit sign is a ramp speed limit sign or an auxiliary road speed limit sign: and determining, based on road information of a first lane on which an intelligent driving device is located and the information about the speed limit sign, whether to alert a user to a speed limit value corresponding to the speed limit sign. The road information of the first lane indicates that the first lane is a main road, a ramp, or an auxiliary road.

The information about the speed limit sign may alternatively be understood as an application scenario, a usage scenario, or a usage type of the speed limit sign.

In an embodiment, the information about the speed limit sign may further indicate that the speed limit sign is a main road speed limit sign.

In an embodiment, the intelligent driving device may obtain navigation positioning information, where the navigation positioning information includes the road information of the first lane.

In an embodiment, after determining to alert the user to the speed limit value, the intelligent driving device may display the speed limit value on a display, or may alert the user to the speed limit value or a change in the speed limit value in a voice form.

The intelligent driving device may determine, based on the information about the speed limit sign and the road information of the first lane, whether to alert the user to the speed limit value of the speed limit sign. In this way, a case in which the intelligent driving device incorrectly selects a speed limit in a complex scenario can be avoided, and accuracy of recognizing a speed limit value by the intelligent driving device is improved.

In some embodiments, the obtaining information about a speed limit sign includes: obtaining a position of the speed limit sign and a feature of the speed limit sign, where the feature of the speed limit sign includes at least one of the following: text, a pattern, and a background color of the speed limit sign: and determining the information about the speed limit sign based on the position of the speed limit sign and the feature of the speed limit sign.

In an embodiment, the position of the speed limit sign and the feature of the speed limit sign may be obtained by a sensor (for example, a camera apparatus) deployed on the intelligent driving device.

The intelligent driving device may determine the information about the speed limit sign based on the position of the speed limit sign and the feature of the speed limit sign. In this way, the information about the speed limit sign can be simply and effectively determined, and whether to alert the user to the speed limit value of the speed limit sign is determined based on the information about the speed limit sign.

In some embodiments, the obtaining information about a speed limit sign includes: obtaining a position of the speed limit sign and a position of a road split point: and determining the information about the speed limit sign based on the position of the speed limit sign and the position of the road split point.

The intelligent driving device may obtain road structure cognitive information, where the road structure cognitive information includes the position of the road split point.

In an embodiment, when a distance between the speed limit sign and the road split point is less than a preset threshold (for example, 5 meters), it may be determined that the speed limit sign is a ramp speed limit sign or an auxiliary road speed limit sign.

In an embodiment, a distance between a branch road center line and the road split point (line) and a distance between a main road center line and the split point (line) may be determined. When a difference between the two distances is less than a preset threshold (for example, 5 meters), a branch road is determined as a ramp. Then, the speed limit sign is determined as a ramp speed limit sign or an auxiliary road speed limit sign with reference to the position of the speed limit sign.

In an embodiment, the speed limit sign may be determined as a ramp speed limit sign or an auxiliary road speed limit sign based on a relative position relationship between the speed limit sign and the road split point and a road hierarchy of the first lane (for example, a national road, a provincial road, or a county road).

The intelligent driving device may determine the information about the speed limit sign based on the position of the speed limit sign and the position of the road split point. In this way, the intelligent driving device can accurately determine the information about the speed limit sign when feature information of the speed limit sign cannot be obtained.

In some embodiments, before the determining, based on road information of a first lane on which an intelligent driving device is located and the information about the speed limit sign, whether to alert a user to a speed limit value corresponding to the speed limit sign, the method further includes: obtaining position information of the intelligent driving device and map speed limit information, where the map speed limit information indicates a speed limit value of the first lane identified on a map; and determining, based on the position information of the intelligent driving device and the map speed limit information, that the first lane is a ramp or an auxiliary road. The determining, based on road information of a first lane on which an intelligent driving device is located and the information about the speed limit sign, whether to alert a user to a speed limit value of the speed limit sign includes: determining, based on the road information of the first lane and the information about the speed limit sign, that the first lane is associated with the speed limit sign; and alerting the user to the speed limit value corresponding to the speed limit sign.

In an embodiment, the intelligent driving device may obtain navigation positioning information, where the navigation positioning information includes the position of the intelligent driving device and the map speed limit information.

The intelligent driving device may comprehensively determine, based on multi-information fusion, whether to alert the user to the speed limit value. In this way, accuracy of speed limit selection performed by the intelligent driving device in a complex scenario can be improved, so that traveling safety of the intelligent driving device is ensured.

In some embodiments, before the determining, based on road information of a first lane on which an intelligent driving device is located and the information about the speed limit sign, whether to alert a user to a speed limit value corresponding to the speed limit sign, the method further includes: obtaining position information of the intelligent driving device; and determining, based on the position information of the intelligent driving device, the position of the speed limit sign, and the position of the road split point, that the first lane is a ramp or an auxiliary road. The determining, based on road information of a first lane on which an intelligent driving device is located and the information about the speed limit sign, whether to alert a user to a speed limit value of the speed limit sign includes: determining, based on the road information of the first lane and the information about the speed limit sign, that the first lane is associated with the speed limit sign; and alerting the user to the speed limit value corresponding to the speed limit sign.

For example, after determining, based on the road structure cognitive information, that there is a split point on the road, the intelligent driving device may determine a speed limit sign that is a distance away from the split point as a ramp speed limit sign or an auxiliary road speed limit sign, and then determine, based on a relative position relationship between the intelligent driving device and the speed limit sign, that the first lane is a ramp or an auxiliary road.

The intelligent driving device may comprehensively determine, based on multi-information fusion, whether to alert the user to the speed limit value. In this way, accuracy of speed limit selection performed by the intelligent driving device in a complex scenario can be improved, so that traveling safety of the intelligent driving device is ensured.

In some embodiments, the obtaining information about a speed limit sign includes: obtaining a first distance and a second distance, where the first distance is a distance between the first lane and a second lane, the second distance is a distance between the second lane and a third lane, the second lane is adjacent to the first lane, and the second lane is adjacent to the third lane; and when a difference between the first distance and the second distance is greater than a first threshold, determining that the speed limit sign is a ramp speed limit sign or an auxiliary road speed limit sign.

In an embodiment, the intelligent driving device may obtain road structure cognitive information, where the road structure cognitive information includes the first distance and the second distance.

When the road split point cannot be recognized by using road structure information, the information about the speed limit sign may be determined based on the difference between the first distance and the second distance, to determine whether to prompt the user with the speed limit value of the speed limit sign.

In some embodiments, the first lane and the second lane are of different road types, and there is an isolation belt between the first lane and the second lane. The determining, based on road information of a first lane on which an intelligent driving device is located and the information about the speed limit sign, whether to alert a user to a speed limit value corresponding to the speed limit sign includes: obtaining a position of the speed limit sign; determining a position of the first lane relative to the isolation belt based on the first distance and the second distance; determining, based on the position of the speed limit sign and the position of the first lane relative to the isolation belt, whether the speed limit sign is associated with the first lane; and when the speed limit sign is associated with the first lane and the road information of the first lane matches the information about the speed limit sign, alerting the user to the speed limit value corresponding to the speed limit sign.

That the first lane and the second lane are of different road types may be: The first lane is a main road, and the second lane is an auxiliary road; or the first lane is an auxiliary road, and the second lane is a main road; or the first lane is a main road, and the second lane is a ramp; or the first lane is a ramp, and the second lane is a main road.

In an embodiment, the first lane may be a rightmost lane on the road.

When there is an isolation belt between the first lane and the second lane, the intelligent driving device may determine a position of the first lane relative to the isolation belt based on the first distance and the second distance, then determine, based on the road information of the first lane and the position of the speed limit sign, whether the speed limit sign is associated with the first lane, and alert the user to the speed limit value of the speed limit sign when the speed limit sign is associated with the first lane.

According an aspect, a warning method is provided. The method includes: detecting that a traffic light is red; detecting that an intelligent driving device is located on a first lane and that the intelligent driving device does not cross a stop line of the first lane; obtaining a third distance between the intelligent driving device and the stop line; and when the third distance is less than or equal to a second threshold, alerting a user that the intelligent driving device runs a red light.

In an embodiment, a sensor (for example, a camera apparatus) deployed on the intelligent driving device may detect that a traffic light is red.

In an embodiment, the detecting that a traffic light is red includes: detecting that the traffic light is red, where the detected red light is a round light or a forward arrow light.

In an embodiment, road information and position information of the intelligent driving device obtained by a sensor (for example, a camera apparatus) deployed on the intelligent driving device may be used to determine that the intelligent driving device is located on the first lane and that the intelligent driving device does not cross the stop line.

In an embodiment, the third distance may be a distance between the intelligent driving device and a keypoint of the stop line.

In an embodiment, the second threshold may be a sum of a reaction distance of the user and a minimum braking distance of the intelligent driving device that are obtained by calculating a speed and an acceleration of the intelligent driving device.

In an embodiment, the intelligent driving device may display a warning red line on a display to alert the user, and at the same time, the intelligent driving device may emit a prompt tone (for example, a bong sound) to alert the user about running a red light.

When the intelligent driving device does not cross the stop line, a relationship between the second threshold and the third distance between the intelligent driving device and the stop line is compared, to determine whether to alert the user about running a red light. In this way, a red-light running warning of the intelligent driving device can be more timely and accurate, and occurrence of a false alarm event can be reduced.

In some embodiments, before the alerting a user that the intelligent driving device runs a red light, the method further includes: detecting that the first lane is a straight lane.

When it is detected that the first lane is a straight lane and the third distance is less than or equal to the second threshold, the intelligent driving device alerts the user about running a red light. In this way, the intelligent driving device can be prevented from alerting about running a red light on a turning lane, so that occurrence of a false alarm event is reduced.

In an aspect, a warning method is provided. The method includes: detecting that a traffic light is red; detecting that an intelligent driving device is located on a first lane and that the intelligent driving device crosses a stop line of the first lane; and when a traveling speed of the intelligent driving device is greater than or equal to a third threshold, alerting a user that the intelligent driving device runs a red light.

In an embodiment, a sensor (for example, a camera apparatus) deployed on the intelligent driving device may detect that a traffic light is red.

In an embodiment, the detecting that a traffic light is red includes: detecting that the traffic light is red, where the detected red light is a round light or a forward arrow light.

In an embodiment, road information and position information of the intelligent driving device obtained by a sensor (for example, a camera apparatus) deployed on the intelligent driving device may be used to determine that the intelligent driving device is located on the first lane and that the intelligent driving device crosses the stop line.

In an embodiment, the intelligent driving device may display a warning red line on a display to alert the user, and at the same time, the intelligent driving device may emit a prompt tone (for example, a bong sound) to alert the user.

When the intelligent driving device crosses the stop line, a relationship between the traveling speed of the intelligent driving device and the third threshold is compared, to determine whether to alert the user about running a red light. In this way, a red-light running warning of the intelligent driving device can be more timely and accurate, so that driving safety of the user is ensured.

In some embodiments, before the alerting a user that the intelligent driving device runs a red light, the method further includes: obtaining a fourth distance between the intelligent driving device and the stop line; and determining that the fourth distance is less than or equal to a fourth threshold.

Before the user is alerted that the intelligent driving device runs a red light, it further needs to be determined that the distance between the intelligent driving device and the stop line is less than the fourth threshold. In this way, a red-light running warning of the intelligent driving device can be more timely and accurate, so that driving safety of the user is ensured.

In an aspect, a warning method is provided. The method is applied to a first intelligent driving device, the first intelligent driving device is located on a first lane, and the method includes: starting a timer when detecting that a traffic light changes from red to green and that a traveling speed of a second intelligent driving device is greater than or equal to a fifth threshold, where the timer is located on the first intelligent driving device, the second intelligent driving device is located on the first lane, and the second intelligent driving device is located in front of the first intelligent driving device; and when detecting that a timing cycle of the timer ends and a traveling speed of the first intelligent driving device is less than or equal to a sixth threshold, prompting a user that the first intelligent driving device has not started to move.

In an embodiment, a sensor (for example, a camera apparatus) deployed on the intelligent driving device may detect that a traffic light changes from red to green.

In an embodiment, the intelligent driving device may display, on a display, a prompt “Green light available for passage”, and alert the user in a manner of emitting a prompt tone (for example, a bong sound).

After the traffic light changes from red to green, when the traveling speed of the second intelligent driving device is greater than or equal to the fifth threshold, the first intelligent driving device starts the timer for timing. The first intelligent driving device gives a warning alert to the user only when the first intelligent driving device fails to start to move before a timeout. In this way, an unreasonable warning generated when there is another intelligent driving device in front of the first intelligent driving device can be avoided, so that driving experience of the user is improved.

Alternatively, the first intelligent driving device starts the timer when detecting that the traffic light changes from red to green, and when detecting that the timing cycle of the timer ends and the traveling speed of the first intelligent driving device is less than or equal to the sixth threshold, prompts the user that the first intelligent driving device has not started to move.

In an aspect, a warning apparatus is provided. The apparatus includes an obtaining unit and a processing unit. The obtaining unit is configured to obtain information about a speed limit sign. The information about the speed limit sign indicates that the speed limit sign is a ramp speed limit sign or an auxiliary road speed limit sign. The processing unit is configured to determine, based on road information of a first lane on which an intelligent driving device is located and the information about the speed limit sign, whether to alert a user to a speed limit value corresponding to the speed limit sign. The road information of the first lane indicates that the first lane is a main road, a ramp, or an auxiliary road.

In some embodiments, the obtaining unit is further configured to obtain a position of the speed limit sign and a feature of the speed limit sign. The feature of the speed limit sign includes at least one of the following: text, a pattern, and a background color of the speed limit sign. The processing unit is further configured to determine the information about the speed limit sign based on the position of the speed limit sign and the feature of the speed limit sign.

In some embodiments, the obtaining unit is further configured to obtain a position of the speed limit sign and a position of a road split point. The processing unit is further configured to determine the information about the speed limit sign based on the position of the speed limit sign and the position of the road split point.

In some embodiments, the obtaining unit is further configured to obtain position information of the intelligent driving device and map speed limit information. The map speed limit information indicates a speed limit value of the first lane identified on a map. The processing unit is further configured to: determine, based on the position information of the intelligent driving device and the map speed limit information, that the first lane is a ramp or an auxiliary road; determine, based on the road information of the first lane and the information about the speed limit sign, that the first lane is associated with the speed limit sign; and alert the user to the speed limit value corresponding to the speed limit sign.

In some embodiments, the obtaining unit is further configured to obtain position information of the intelligent driving device. The processing unit is further configured to: determine, based on the position information of the intelligent driving device, the position of the speed limit sign, and the position of the road split point, that the first lane is a ramp or an auxiliary road. The determining, based on road information of a first lane on which an intelligent driving device is located and the information about the speed limit sign, whether to alert a user to a speed limit value of the speed limit sign includes: determining, based on the road information of the first lane and the information about the speed limit sign, that the first lane is associated with the speed limit sign; and alerting the user to the speed limit value corresponding to the speed limit sign.

In some embodiments, the obtaining unit is further configured to obtain a first distance and a second distance. The first distance is a distance between the first lane and a second lane, the second distance is a distance between the second lane and a third lane, the second lane is adjacent to the first lane, and the second lane is adjacent to the third lane. The processing unit is further configured to: when a difference between the first distance and the second distance is greater than a first threshold, determine that the speed limit sign is a ramp speed limit sign or an auxiliary road speed limit sign.

In some embodiments, the first lane and the second lane are of different road types, and there is an isolation belt between the first lane and the second lane. The obtaining unit is further configured to obtain a position of the speed limit sign. The processing unit is further configured to: determine a position of the first lane relative to the isolation belt based on the first distance and the second distance; determine, based on the position of the speed limit sign and the position of the first lane relative to the isolation belt, whether the speed limit sign is associated with the first lane; and when the speed limit sign is associated with the first lane and the road information of the first lane matches the information about the speed limit sign, alert the user to the speed limit value corresponding to the speed limit sign.

In an aspect, a warning apparatus is provided. The apparatus includes an obtaining unit and a processing unit. The processing unit is configured to: detect that a traffic light is red; and detect that an intelligent driving device is located on a first lane and that the intelligent driving device does not cross a stop line of the first lane. The obtaining unit is configured to obtain a third distance between the intelligent driving device and the stop line. The processing unit is further configured to: when the third distance is less than or equal to a second threshold, alert a user that the intelligent driving device runs a red light.

In some embodiments, the processing unit is further configured to detect that the first lane is a straight lane.

In an aspect, a warning apparatus is provided. The apparatus includes a processing unit. The processing unit is configured to: detect that a traffic light is red; detect that an intelligent driving device is located on a first lane and that the intelligent driving device crosses a stop line of the first lane; and when a traveling speed of the intelligent driving device is greater than or equal to a third threshold, alert a user that the intelligent driving device runs a red light.

In some embodiments, the apparatus further includes an obtaining unit. The obtaining unit is configured to obtain a fourth distance between the intelligent driving device and the stop line. The processing unit is further configured to determine that the fourth distance is less than or equal to a fourth threshold.

In an aspect, a warning apparatus is provided. The apparatus is applied to a first intelligent driving device, the first intelligent driving device is located on a first lane, and the apparatus includes a processing unit. The processing unit is configured to: start a timer when detecting that a traffic light changes from red to green and that a traveling speed of a second intelligent driving device is greater than or equal to a fifth threshold, where the timer is located on the first intelligent driving device, the second intelligent driving device is located on the first lane, and the second intelligent driving device is located in front of the first intelligent driving device; and when detecting that a timing cycle of the timer ends and a traveling speed of the first intelligent driving device is less than or equal to a sixth threshold, prompt a user that the first intelligent driving device has not started to move.

In an aspect, a warning apparatus is provided. The apparatus includes at least one processor and a memory. The at least one processor is coupled to the memory, and is configured to read and execute instructions in the memory; to enable the apparatus to implement the method in any implementation of the first aspect to the fourth aspect.

In an aspect, a computer-readable storage medium is provided. The computer-readable storage medium stores program code, and when the computer program code is run on a computer, the computer is enabled to perform the method in any implementation of the first aspect to the fourth aspect.

In an aspect, a chip is provided. The chip includes a circuit, and the circuit is configured to perform the method in any implementation of the first aspect to the fourth aspect.

In an aspect, a computer program product is provided. The computer product includes a computer program, and when the computer program is run, a computer is enabled to perform the method in any implementation of the first aspect to the fourth aspect.

In an aspect, an intelligent driving device is provided, including the apparatus in any implementation of the fifth aspect to the eighth aspect.

In an aspect, a server is provided, including the apparatus in any implementation of the fifth aspect or the eighth aspect.

### BRIEF DESCRIPTION OF DRAWINGS

FIG. 1 is a functional diagram of an intelligent driving device according to an embodiment of this application;

FIG. 2 shows an architecture to which a warning method is applicable according to an embodiment of this application;

FIG. 3 is a schematic flowchart of a warning method according to an embodiment of this application;

FIG. 4A and FIG. 4B are a schematic flowchart of another warning method according to an embodiment of this application;

FIG. 5 is a schematic flowchart of another warning method according to an embodiment of this application;

FIG. 6 is a schematic flowchart of speed limit recognition based on a ramp scenario according to an embodiment of this application;

FIG. 7(a), FIG. 7(b), and FIG. 7(c) are a diagram of speed limit recognition based on a ramp scenario according to an embodiment of this application;

FIG. 8 is a schematic flowchart of speed limit recognition based on a main and auxiliary road scenario according to an embodiment of this application;

FIG. 9(a), FIG. 9(b), and FIG. 9(c) is a diagram of speed limit recognition based on a main and auxiliary road scenario according to an embodiment of this application;

FIG. 10 is a schematic flowchart of another warning method according to an embodiment of this application;

FIG. 11 is a schematic flowchart of another warning method according to an embodiment of this application;

FIG. 12 is a schematic flowchart of another warning method according to an embodiment of this application;

FIG. 13 is a diagram of a red-light running warning scenario based on an unmarked crosswalk of a T-intersection according to an embodiment of this application;

FIG. 14 is a diagram of an application scenario for a vehicle start-to-move alert according to an embodiment of this application;

FIG. 15 is a diagram of a warning apparatus according to an embodiment of this application; and

FIG. 16 is a diagram of another warning apparatus according to an embodiment of this application.

### DESCRIPTION OF EMBODIMENTS

In descriptions of embodiments of this application, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists. In this application, “at least one” means one or more, and “a plurality of” means two or more. “At least one of the following” or a similar expression thereof means any combination of these items, including any combination of single items or a plurality of items. For example, at least one of a, b, or c may represent a, b, c, a and b, a and c, b and c, or a, b, and c, where a, b, and c may be singular or plural.

Prefix words “first”, “second”, and the like in embodiments of this application are merely intended to distinguish between different objects, and impose no limitation on positions, sequences, priorities, quantities, content, or the like of the described objects. Use of prefix words such as ordinal numbers used to distinguish the described objects in embodiments of this application does not constitute a limitation on the described objects. For descriptions of the described objects, refer to the context description in claims or embodiments, and the use of such prefix words should not constitute a redundant limitation.

The following describes technical solutions of embodiments in this application with reference to accompanying drawings.

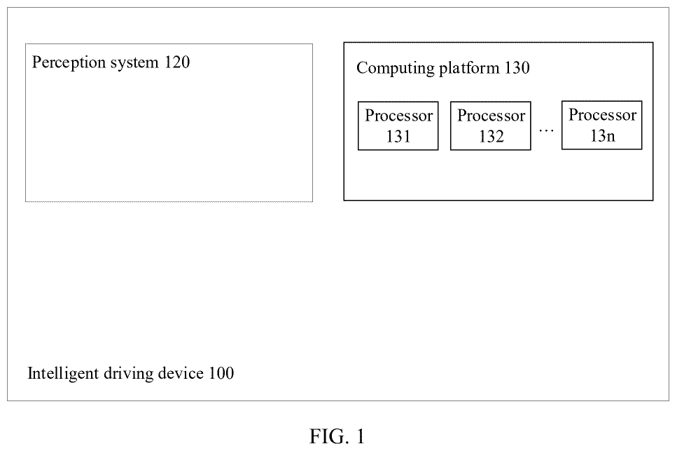

FIG. 1 is a functional diagram of an intelligent driving device 100 according to an embodiment of this application.

The intelligent driving device 100 may include a plurality of subsystems, for example, a perception system 120 and a computing platform 130. In an embodiment, the intelligent driving device 100 may include more or fewer subsystems, and each subsystem may include one or more components. In addition, each subsystem and component of the intelligent driving device 100 may implement interconnection in a wired or wireless manner.

The perception system 120 may include several types of sensors configured to perceive ambient environment information of the intelligent driving device 100. For example, the perception system 120 may include a positioning system. The positioning system may be a global positioning system (GPS), a BeiDou system, or another positioning system. The perception system 120 may include one or more of an inertial measurement unit (inertial measurement unit, IMU), a lidar, a millimeter-wave radar, an ultrasonic radar, and a camera apparatus.

Some or all functions of the intelligent driving device 100 may be controlled by the computing platform 130. The computing platform 130 may include processors 131 to 13n (n is a positive integer). The processor is a circuit with a signal processing capability. In an embodiment, the processor may be a circuit with an instruction reading and running capability, for example, a central processing unit (CPU), a microprocessor, a graphics processing unit (GPU) (which may be understood as a microprocessor), or a digital signal processor (DSP). In another embodiment, the processor may implement a function based on a logical relationship of a hardware circuit. The logical relationship of the hardware circuit is fixed or reconfigurable. For example, the processor is a hardware circuit implemented by an application-specific integrated circuit (ASIC) or a programmable logic device (PLD), for example, an FPGA. In a reconfigurable hardware circuit, a process in which the processor loads a configuration document to implement hardware circuit configuration may be understood as a process in which the processor loads instructions to implement functions of some or all of the units. In addition, the processor may alternatively be a hardware circuit designed for artificial intelligence, and may be understood as an ASIC, for example, a neural network processing unit (NPU), a tensor processing unit (tensor processing unit, TPU), or a deep learning processing unit (DPU). In addition, the computing platform 130 may further include a memory. The memory is configured to store instructions. Some or all of the processors 131 to 13n may invoke the instructions in the memory, to implement corresponding functions.

The computing platform 130 may control functions of the intelligent driving device 100 based on inputs received from various subsystems (for example, the perception system 120). In some embodiments, the computing platform 130 may be configured to provide control over a plurality of aspects of the intelligent driving device 100 and subsystems of the intelligent driving device 100.

In an embodiment, the foregoing components are merely examples. In actual application, components in the foregoing modules may be added or removed according to an actual requirement.

The intelligent driving device 100 in this application may include a transportation tool on a road, a transportation tool on water, an air transportation tool, an industrial device, an agricultural device, an entertainment device, or the like. For example, the intelligent driving device 100 may be a vehicle. The vehicle is a vehicle in a broad sense, and may be a transportation means (for example, a commercial vehicle, a passenger vehicle, a motorcycle, a flight vehicle, or a train), an industrial vehicle (for example, a pallet truck, a trailer, or a tractor), an engineering vehicle (for example, an excavator, a bulldozer, or a crane), an agricultural device (for example, a lawn mower or a harvester), a recreational device, a toy vehicle, or the like. A type of the vehicle is not limited in embodiments of this application. For another example, the intelligent driving device 100 may be a transportation means such as an airplane or a ship.

The following uses an example in which an intelligent driving device 100 is a vehicle to describe a technical problem to be resolved in this application and a technical solution used in this application.

As intelligent vehicles are widely used in daily life, users expect that the intelligent vehicles can bring more comfortable intelligent experience. In this context, TSR has emerged. The TSR may use a camera to recognize a common traffic sign, to alert drivers to a speed limit change, and protect driving safety of the users to a large extent.

However, in an actual application process of the TSR, when a vehicle is in a complex scenario (for example, a ramp, or urban main and auxiliary roads), the vehicle is prone to incorrectly select a speed limit, which seriously affects driving experience of the users and may even pose a threat to life safety of the users.

For example, when the vehicle is traveling on a ramp at a speed greater than 60 km/h, and a speed limit of the ramp is 60 km/h, the vehicle incorrectly selects a speed limit value of 120 km/h on an expressway adjacent to the ramp, which may pose a threat to life safety of the users.

Embodiments of this application relate to a warning method and apparatus, and an intelligent driving device, to avoid a case in which the intelligent driving device incorrectly selects a speed limit in a complex traveling scenario, and improve accuracy of speed limit recognition.

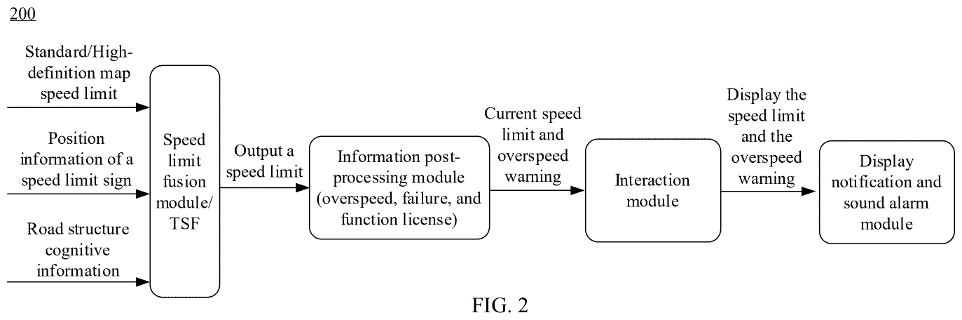

FIG. 2 shows an architecture to which a warning method is applicable according to an embodiment of this application. The architecture may be applied to the intelligent driving device 100 in FIG. 1.

As shown in FIG. 2, an architecture 200 may include a speed limit fusion module or a traffic sign fusion (TSF) module, an information post-processing module, an interaction module, and a display notification and sound alarm module. The speed limit fusion module or the traffic sign fusion module may receive information (for example, speed limit information of a standard map or a high-definition map, position information of a speed limit sign, and road structure cognitive information), perform fusion processing, and output a speed limit to the information post-processing module. The information post-processing module may perform post-processing on the speed limit output by the speed limit fusion module or the traffic sign fusion module, to determine whether the vehicle is speeding, is faulty, or the like, and determine whether a function license is available. If the foregoing situations exist, the information post-processing module may send information such as a current speed limit and an overspeed warning to the interaction module. After receiving the information such as the current speed limit and the overspeed warning, the interaction module may forward the information to the display notification and sound alarm module. After receiving the information such as the current speed limit and the overspeed warning, the display notification and sound alarm module may alert the user to a speed limit value of a current road in different manners (for example, a display notification or a voice assistant reminder).

The standard map may also be referred to as a standard navigation map. The speed limit fusion module, the traffic sign fusion module, the information post-processing module, the interaction module, and the display notification and sound alarm module may be located in the computing platform 130 in FIG. 1.

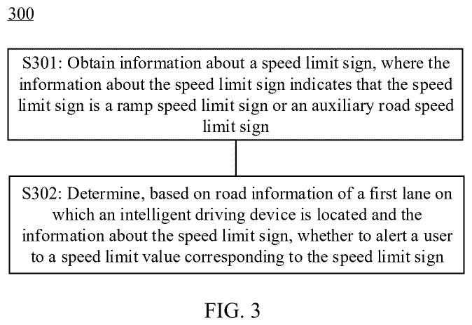

FIG. 3 is a schematic flowchart of a warning method according to an embodiment of this application. An execution body of the method 300 may be an intelligent driving device. When the execution body of the method 300 is the intelligent driving device 100, the method 300 may be performed by the computing platform 130 in the intelligent driving device 100, or may be performed by a system-on-chip (SoC) in the computing platform 130, or may be performed by a processor in the computing platform 130. The following describes the method 300 by using the intelligent driving device as the execution body. The method 300 may include operation S301 and operation S302.

S301: Obtain information about a speed limit sign, where the information about the speed limit sign indicates that the speed limit sign is a ramp speed limit sign or an auxiliary road speed limit sign.

The information about the speed limit sign may alternatively be understood as an application scenario, a usage scenario, or a usage type of the speed limit sign.

In an embodiment, the information about the speed limit sign may further indicate that the speed limit sign is a main road speed limit sign.

In an embodiment, operation S301 includes: obtaining a position of the speed limit sign and a feature of the speed limit sign, where the feature of the speed limit sign includes at least one of the following: text, a pattern, and a background color of the speed limit sign; and determining the information about the speed limit sign and a speed limit value based on the position of the speed limit sign and the feature of the speed limit sign.

In an embodiment, the position of the speed limit sign and the feature of the speed limit sign may be obtained by a sensor (for example, a camera apparatus) deployed on the intelligent driving device.

In an embodiment, the text of the speed limit sign may be understood as Chinese characters. For example, text information of “ramp” is marked on a traffic sign below the speed limit sign.

In an embodiment, operation S301 includes: obtaining a position of the speed limit sign and a position of a road split point; and determining the information about the speed limit sign based on the position of the speed limit sign and the position of the road split point.

The intelligent driving device may obtain road structure cognitive information, where the road structure cognitive information includes the position of the road split point.

In an embodiment, a distance between a branch road center line and the road split point (line) and a distance between a main road center line and the split point (line) may be determined. When a difference between the two distances is less than a preset threshold (for example, 5 meters), a branch road is determined as a ramp. Then, the speed limit sign is determined as a ramp speed limit sign or an auxiliary road speed limit sign with reference to the position of the speed limit sign.

In an embodiment, the speed limit sign may be determined as a ramp speed limit sign, a main road speed limit sign, or an auxiliary road speed limit sign based on a relative position relationship between the speed limit sign and the road split point and a road hierarchy of a first lane (for example, a national road, a provincial road, or a county road). In this way, a determined result can be more accurate.

In an embodiment, operation S301 includes: obtaining a first distance and a second distance, where the first distance is a distance between the first lane and a second lane, the second distance is a distance between the second lane and a third lane, the second lane is adjacent to the first lane, and the second lane is adjacent to the third lane; and when a difference between the first distance and the second distance is greater than a first threshold, determining that the speed limit sign is a ramp speed limit sign or an auxiliary road speed limit sign.

In an embodiment, the intelligent driving device may obtain road structure cognitive information, where the road structure cognitive information includes the first distance and the second distance.

For example, a road includes three lanes, a 1^{st} lane is the first lane, a 2^{nd} lane is the second lane, and a 3^{rd} lane is the third lane. When the difference between the first distance and the second distance is greater than the first threshold, it is determined that the speed limit sign is a ramp speed limit sign or an auxiliary road speed limit sign. Otherwise, it is determined that the speed limit sign is a main road speed limit sign. In an embodiment, there may be a road split point between the 1^{st} lane and the 2^{nd} lane. In an embodiment, the 1^{st} lane may be an auxiliary road or a ramp, and the 2^{nd} lane may be a main road.

For example, if the first distance is 10 meters, the second distance is 4 meters, and the first threshold is 5 meters, it is determined that the speed limit sign is a ramp speed limit sign or an auxiliary road speed limit sign.

For example, the road includes six lanes, a 4^{th} lane is the first lane, a 5^{th} lane and a 3^{rd} lane are second lanes, and a 6^{th} lane and a 2^{nd} lane are third lanes. In this case, if a difference between a first distance between the 4^{th} lane and the 5^{th} lane and a second distance between the 5^{th} lane and the 6^{th} lane is greater than the first threshold, or a difference between a first distance between the 3^{rd} lane and the 4^{th} lane and a second distance between the 2^{nd} lane and the 3^{rd} lane is greater than the first threshold, it is determined that the speed limit sign is a ramp speed limit sign or an auxiliary road speed limit sign. Otherwise, it is determined that the speed limit sign is a main road speed limit sign. In an embodiment, there may be a road split point between the 3^{rd} lane and the 4^{th} lane, or there may be a road split point between the 4th lane and the 5^{th} lane. In an embodiment, the 4^{th} lane may be a ramp or an auxiliary road, and the 3^{rd} lane or the 5^{th} lane may be a main road.

It should be understood that the foregoing examples in which the road includes three lanes and six lanes are used for description. The method 300 may alternatively be applied, by analogy, to a case in which the road includes N lanes, where N may be an integer greater than 3.

S302: Determine, based on road information of the first lane on which the intelligent driving device is located and the information about the speed limit sign, whether to alert a user to a speed limit value corresponding to the speed limit sign.

The road information of the first lane indicates that the first lane is a main road, a ramp, or an auxiliary road.

For example, if the road information of the first lane indicates that the first lane is a ramp, and the information about the speed limit sign indicates that the speed limit sign is a ramp, the intelligent driving device may determine to alert the user to the speed limit value of the speed limit sign.

In an embodiment, the intelligent driving device may obtain navigation positioning information, where the navigation positioning information includes the road information of the first lane.

In an embodiment, after determining to alert the user to the speed limit value, the intelligent driving device may display the speed limit value on a display, and may alert the user to the speed limit value or a change in the speed limit value in a voice form.

In an embodiment, before operation S302, the method 300 further includes: obtaining position information of the intelligent driving device and map speed limit information, where the map speed limit information indicates a speed limit value of the first lane identified on a map; and determining, based on the position information of the intelligent driving device and the map speed limit information, that the first lane is a ramp or an auxiliary road. Operation S302 includes: determining, based on the road information of the first lane and the information about the speed limit sign, that the first lane is associated with the speed limit sign; and alerting the user to the speed limit value corresponding to the speed limit sign. In this way, accuracy of speed limit selection performed by the intelligent driving device in a complex scenario can be improved, so that traveling safety of the intelligent driving device is ensured.

In an embodiment, the intelligent driving device may obtain navigation positioning information, where the navigation positioning information includes the position information of the intelligent driving device and the map speed limit information.

In an embodiment, the position information of the intelligent driving device may be coordinates of the intelligent driving device on the earth, or position coordinates of the intelligent driving device on a navigation map.

For example, the intelligent driving device may determine coordinates of the intelligent driving device in the map by using the navigation positioning information, and determine that a map speed limit value of a lane at the coordinates is 60 km/h. In this case, it may be determined that the first lane is a ramp or an auxiliary road.

In an embodiment, before operation S302, the method 300 further includes: obtaining position information of the intelligent driving device; and determining, based on the position information of the intelligent driving device, the position of the speed limit sign, and the position of the road split point, that the first lane is a ramp or an auxiliary road. Operation S302 includes: determining, based on the road information of the first lane and the information about the speed limit sign, that the first lane is associated with the speed limit sign; and alerting the user to the speed limit value corresponding to the speed limit sign. In this way, the intelligent driving device may comprehensively determine, based on multi-information fusion, whether to alert the user to the speed limit value.

For example, after determining, based on the road structure cognitive information, that there is a split point on the road, the intelligent driving device may determine a speed limit sign that is a distance (for example, 5 meters) away from the split point as a ramp speed limit sign or an auxiliary road speed limit sign, and then determine, based on a relative position relationship between the intelligent driving device and the speed limit sign, that the first lane is a ramp or an auxiliary road.

In an embodiment, operation S301 includes: obtaining a first distance and a second distance. The first distance is a distance between the first lane and a second lane, the second distance is a distance between the second lane and a third lane, the second lane is adjacent to the first lane, and the second lane is adjacent to the third lane. The first lane and the second lane are of different road types, and there is an isolation belt between the first lane and the second lane. Operation S302 includes: obtaining a position of the speed limit sign; determining a position of the first lane relative to the isolation belt based on the first distance and the second distance; determining, based on the position of the speed limit sign and the position of the first lane relative to the isolation belt, whether the speed limit sign is associated with the first lane; and when the speed limit sign is associated with the first lane and the road information of the first lane matches the information about the speed limit sign, alerting the user to the speed limit value corresponding to the speed limit sign.

In an embodiment, that the first lane and the second lane are of different road types may be: The first lane is a main road, and the second lane is an auxiliary road; or the first lane is an auxiliary road, and the second lane is a main road; or the first lane is a main road, and the second lane is a ramp; or the first lane is a ramp, and the second lane is a main road.

In an embodiment, the position of the first lane relative to the isolation belt may be understood as that the first lane is on a left side or a right side of the isolation belt.

In an embodiment, if the first lane and the speed limit sign are located on a same side of the isolation belt, it may be considered that the speed limit sign is associated with the first lane.

For example, if the information about the speed limit sign indicates that the speed limit sign is a ramp speed limit sign, and the road information of the first lane indicates that the first lane is a ramp, it may be considered that the road information of the first lane matches the information about the speed limit sign. Alternatively, if the information about the speed limit sign indicates that the speed limit sign is an auxiliary road speed limit sign, and the road information of the first lane indicates that the first lane is an auxiliary road, it may be considered that the road information of the first lane matches the information about the speed limit sign.

In this embodiment of this application, the intelligent driving device may determine, based on the information about the speed limit sign and the road information of the first lane, whether to alert the user to the speed limit value of the speed limit sign. In this way, a case in which the intelligent driving device incorrectly selects a speed limit in a complex scenario can be avoided, and accuracy of recognizing a speed limit value by the intelligent driving device is improved.

It should be understood that in embodiments of this application, unless otherwise stated or there is a logic conflict, terms and/or descriptions in all embodiments are consistent and may be mutually referenced, and technical features in different embodiments may be combined based on an internal logical relationship thereof, to form a new embodiment.

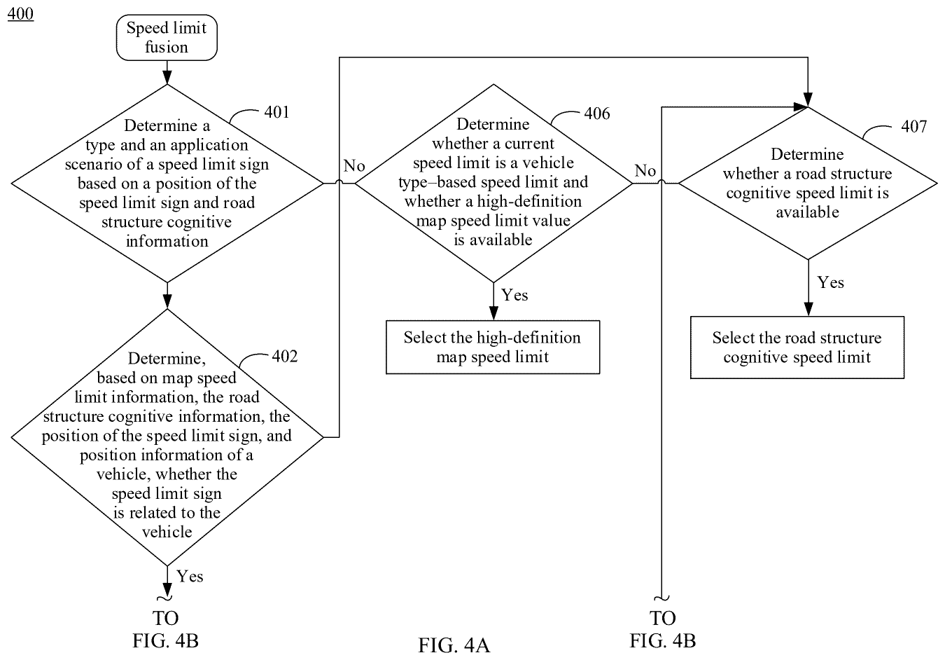

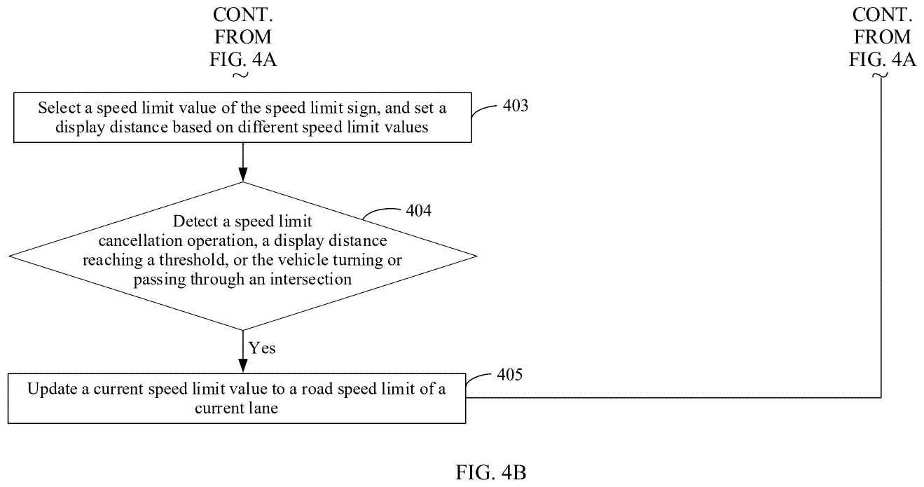

FIG. 4A and FIG. 4B are a schematic flowchart of another warning method according to an embodiment of this application. A method 400 may be performed by the speed limit fusion module or the traffic sign fusion module in FIG. 2. The method 400 may be a detailed description of operations S301 and S302 in the method 300. The method 400 may include the following operations.

S401: Determine a type and an application scenario of a speed limit sign based on a position of the speed limit sign and road structure cognitive information.

After the application scenario of the speed limit sign is determined, whether a vehicle selects the speed limit may be determined based on the application scenario. The vehicle may be the intelligent driving device in the method 300.

In an embodiment, before operation S401, the method 400 may further include: determining whether the vehicle matches a map version; and if the vehicle matches the map version, performing operation S401; or otherwise, ending the method 400.

In an embodiment, if the type and the application scenario of the speed limit sign are determined in operation S401, operation S402 may be performed; or otherwise, operation S406 may be performed.

S402: Determine, based on map speed limit information, the road structure cognitive information, the position of the speed limit sign, and position information of the vehicle, whether the speed limit sign is related to the vehicle.

When the speed limit sign is related to the vehicle, operation S403 may be performed; or otherwise, operation S407 is performed.

S403: Select a speed limit value of the speed limit sign, and set a display distance based on different speed limit values.

The display distance may be understood as follows: The vehicle selects a speed limit value of the speed limit sign within the display distance, and after the display distance of the vehicle reaches a threshold, the vehicle no longer uses the speed limit value of the speed limit sign, or the speed limit value of the vehicle is updated to a road speed limit of a current lane.

S404: Detect a speed limit cancellation operation, a display distance reaching a threshold, or the vehicle turning or passing through an intersection.

In an embodiment, the detecting a speed limit cancellation operation includes: detecting an operation of canceling a speed limit sign, where a value of the canceled speed limit sign is equal to a current speed limit value.

S405: Update the current speed limit value to a road speed limit of the current lane.

S406: Determine whether a current speed limit is a vehicle type-based speed limit and whether a high-definition map speed limit value is available.

If the current speed limit is a vehicle type-based speed limit, and the high-definition map speed limit value is available, the vehicle may use the high-definition map speed limit value; or otherwise, operation S407 may be performed.

S407: Determine whether a road structure cognitive speed limit is available.

When the road structure cognitive speed limit is available and no speed limit sign is recognized, a road structure cognitive speed limit value may be selected.

In this embodiment of this application, the vehicle may perform fusion processing by using multi-source information (including the map speed limit information, the road structure cognitive information, position information of the speed limit sign, and the position information of the vehicle), so that accuracy of speed limit selection of the vehicle is improved and driving safety is improved.

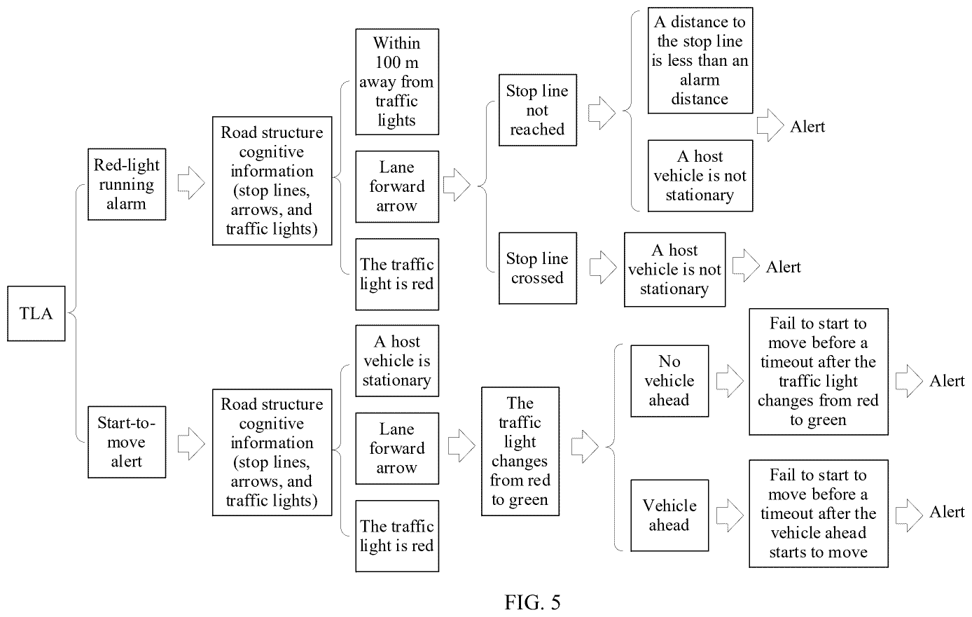

FIG. 5 is a schematic flowchart of another warning method according to an embodiment of this application. The method 500 may include two parts: a red-light running alert and a start-to-move alert.

### (1) Red-Light Running Alarm

When a vehicle is in a user driving or an adaptive cruise control (adaptive cruise control, ACC) mode on a straight lane, and a distance to a traffic light is less than or equal to a preset distance (for example, 100 meters), the vehicle may give an alarm if the vehicle does not reach a stop line and a distance from the vehicle to the stop line is less than an alarm distance (determined based on a minimum braking distance and a reaction distance of a driver that are calculated based on a current vehicle speed and an acceleration). Alternatively, if the vehicle crosses the stop line and is not stationary after reaching the stop line, the vehicle may give an alarm. The alarm distance may be a second threshold in a method 1000.

In an embodiment, the vehicle may display a warning red line on a display to give an alarm, or the vehicle may emit a prompt tone (for example, a bong sound) to give an alarm.

### (2) Start-to-Move Alert

When the vehicle is in the user driving mode and waiting for passage in a straight lane, if the traffic light changes from red to green and there is no vehicle in front of the vehicle, but the vehicle fails to start to move before a timeout, the vehicle may issue a reminder. Alternatively, if there is a vehicle ahead, but the host vehicle fails to start to move before a timeout after the vehicle ahead starts to move, the vehicle may issue a reminder.

In an embodiment, the vehicle may display, on a display, a prompt “Green light available for passage”, and give an alarm in a manner of emitting a prompt tone (for example, a bong sound) at the same time.

In this embodiment of this application, when the vehicle stops at an intersection, the user may be warned in two manners: a red-light running alarm and a start-to-move alert, so that driving safety is improved.

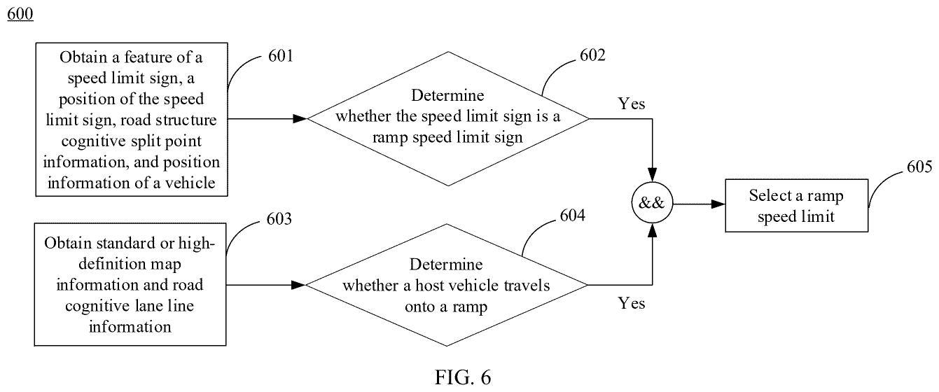

FIG. 6 is a schematic flowchart of speed limit recognition based on a ramp scenario according to an embodiment of this application. A method 600 may be a detailed description of operations S301 and S302 in the method 300. The method 600 may include the following operations.

S601: Obtain a feature of a speed limit sign, a position of the speed limit sign, road structure cognitive split point information, and position information of a vehicle.

S602: Determine, based on the feature of the speed limit sign, the position of the speed limit sign, the road structure cognitive split point information, and the position information of the vehicle, whether the speed limit sign is a ramp speed limit sign.

S603: Obtain standard or high-definition map information and road structure cognitive lane line information.

S604: Determine, based on the standard or high-definition map information, the road structure cognitive lane line information, and the position information of the vehicle, whether the vehicle travels onto a ramp.

The standard or high-definition map information may be the map speed limit information in the method 300.

S605: When determining that the speed limit sign is the ramp speed limit sign and the vehicle travels onto the ramp, select a ramp speed limit.

Because the ramp speed limit is a difficult scenario for TSR, the vehicle is prone to incorrectly select a speed limit. In this embodiment of this application, whether a type of the speed limit sign is a ramp speed limit sign may be determined by obtaining the feature of the speed limit sign, the position of the speed limit sign, the road structure cognitive split point information, and the position information of the vehicle, and then whether the vehicle travels onto the ramp is determined based on the standard or high-definition map information, the position information of the vehicle, and the road structure cognitive lane line information, to determine whether to select a speed limit.

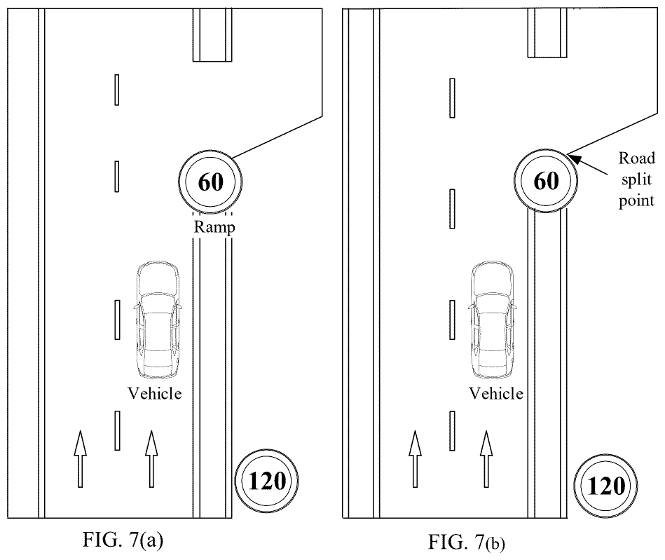

The following uses FIG. 7(a), FIG. 7(b), and FIG. 7(c) as examples to describe a various application scenarios of the method 600.

In an embodiment, as shown in FIG. 7(a), after obtaining text information “Ramp” under the speed limit sign, the vehicle may bind the position of the speed limit sign to text “Ramp” of the text information, to determine that the speed limit sign is a ramp speed limit sign. Then, the vehicle may determine, based on the position information of the vehicle, the position of the speed limit sign, and the standard map or the high-definition map information, whether the vehicle is on the ramp, to determine whether to select a speed limit value of the speed limit sign, that is, determine whether to select a speed limit value of 60 km/h or 120 km/h.

In an embodiment, the vehicle may further determine, based on features such as text, a pattern, and a background color of the speed limit sign, whether the speed limit sign is a ramp speed limit sign.

In an embodiment, as shown in FIG. 7(b), when the vehicle travels on a highway or an urban expressway, if the road structure cognitive information includes a split point (split point), the vehicle may determine, based on the position of the speed limit sign and a relative position of the split point, whether the speed limit sign is a ramp sign. Then, the vehicle may determine, based on a position relationship between the vehicle and the speed limit sign and the standard map or high-definition map information, whether the vehicle is on the ramp, to determine whether to select a speed limit, that is, determine whether to select a speed limit of 60 km/h or 120 km/h.

For example, when a distance between the speed limit sign and the road split point is less than a preset threshold (for example, 500 meters), it is determined that the speed limit sign is the ramp speed limit sign.

In an embodiment, as shown in FIG. 7(c), when (di-dgate) in the road structure cognitive information>a preset threshold (for example, 5 meters), it may be determined that a current traveling road of the vehicle is a ramp, and a speed limit sign recognized by the vehicle is a ramp speed limit sign. In this case, the speed limit sign may be bound to one side of a branch road based on a distance from the speed limit sign to each lane. If the speed limit sign and the vehicle are on a same side of the branch road, the speed limit may be selected (that is, the speed limit of 60 km/h). Otherwise, the speed limit is discarded.

di may be a distance between a center line of the branch road and a center line of an adjacent road, and dgate may be understood as a distance between center lines of two adjacent non-branch roads. di may be the first distance in the method 300, and dgate may be the second distance in the method 300.

In this embodiment of this application, a plurality of solutions for determining a speed limit are proposed based on a ramp scenario, so that accuracy of fusion recognition of a ramp speed limit can be improved, and a problem of incorrect speed limit selection in a ramp scenario can be resolved.

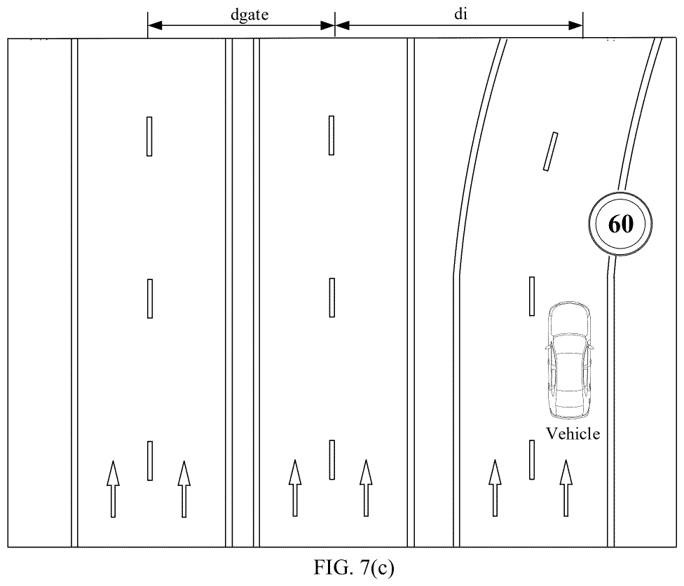

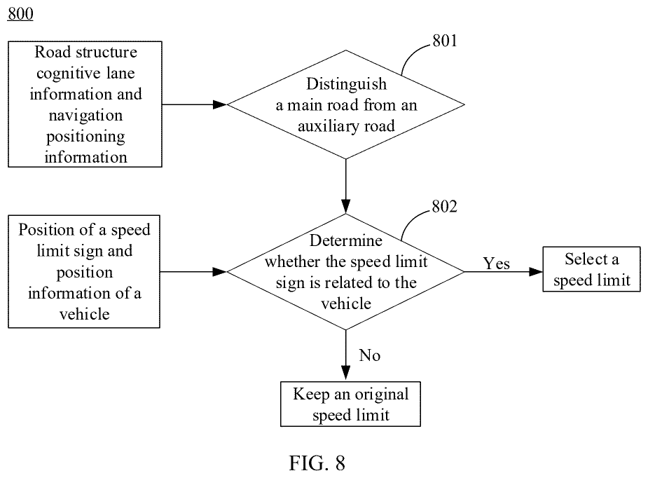

FIG. 8 is a schematic flowchart of speed limit recognition based on a main and auxiliary road scenario according to an embodiment of this application. A method 800 may be a detailed description of operations S301 and S302 in the method 300. The method 800 may include the following operations.

S801: Distinguish a main road from an auxiliary road based on road structure cognitive lane information and navigation positioning information.

In an embodiment, before operation S801, the method 800 further includes: obtaining the road structure cognitive lane information and the navigation positioning information.

The main road may be understood as a road with large vehicle traffic, a high vehicle speed, and no non-motorized vehicle or pedestrian. The auxiliary road may be understood as a road with motorized vehicles, non-motorized vehicles, and pedestrians.

S802: Determine, based on a position of a speed limit sign and position information of a vehicle, whether the speed limit sign is related to the vehicle.

If it is determined that the speed limit sign is related to the vehicle, speed limit selection may be performed; or otherwise, the vehicle may keep an original speed limit.

In an embodiment, operation S802 may further include: determining, based on the position of the speed limit sign, the position information of the vehicle, and road hierarchy information, whether the speed limit sign is related to the vehicle.

In a current road perception technology, it is difficult to distinguish between a speed limit on the main road and a speed limit on the auxiliary road. In this embodiment of this application, the main road and the auxiliary road are distinguished based on the road structure cognitive lane information and the navigation positioning information, and whether the speed limit sign is related to the vehicle is determined based on position information of the speed limit sign and the position information of the vehicle, to determine whether to select a speed limit. In this way, accuracy of speed limit fusion recognition of the main and auxiliary roads can be improved.

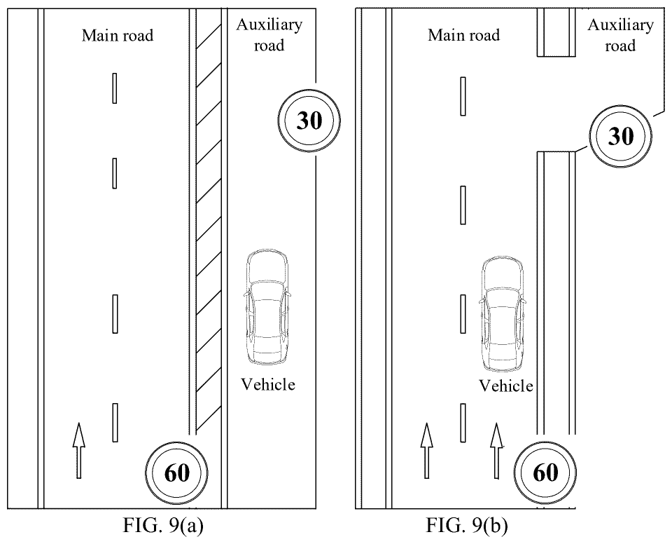

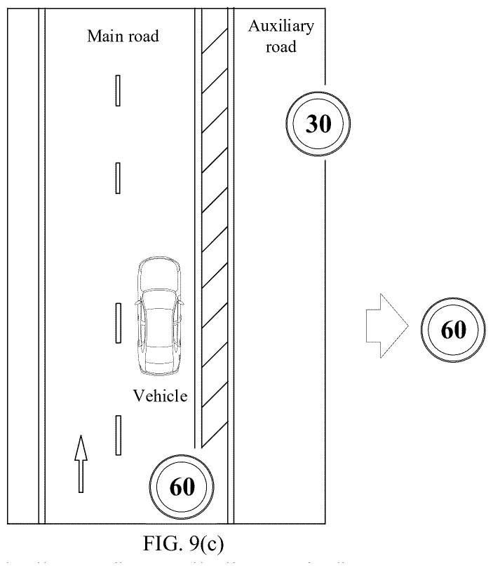

The following uses FIG. 9(a), FIG. 9(b), and FIG. 9(c) as examples to describe application scenarios of the method 800.

In an embodiment, as shown in FIG. 9(a), the vehicle obtains position information of the speed limit sign (including a speed limit sign at 30 km/h and a speed limit sign at 60 km/h), and determines a distance from the speed limit sign to a rightmost lane of a road on which the vehicle travels. If the distance is less than or equal to a first preset distance, or the distance is greater than the first preset distance and less than a second preset distance, and a speed limit value displayed on the speed limit sign is equal to a speed limit value on a map, it is determined that the speed limit sign is related to the vehicle, and the speed limit is selected, that is, select a speed limit value of 30 km/h in FIG. 9(a).

For example, the first preset distance is 9 meters, and the second preset distance is 10 meters.

In an embodiment, as shown in FIG. 9(b), road structure cognitive information includes position information of a split point and road hierarchy information, and the vehicle may determine, based on the foregoing information, whether a current traveling road is a main road or an auxiliary road. Then, the vehicle may determine, based on a relative position relationship between the split point and the speed limit sign, whether the current speed limit sign is an auxiliary road speed limit sign, and then determine, based on a position relationship between the vehicle and the speed limit sign, whether the speed limit sign is related to the vehicle, to determine whether to select a speed limit, that is, select a speed limit value of 60 km/h in FIG. 9(b).

In an embodiment, the road hierarchy information may include a national road, a provincial road, a county road, and the like.

In an embodiment, the road hierarchy information may further include an expressway, an urban expressway, a suburban road, and the like.

In an embodiment, as shown in FIG. 9(c), when there is an isolation belt between the main road and the auxiliary road, a difference between distances between each lane and a rightmost lane may be calculated to determine positions of lanes on two sides of the isolation belt, and then a correlation between the speed limit sign and the vehicle is determined by determining whether the speed limit sign and the vehicle are located on a same side of the isolation belt, to determine whether to select a speed limit value. That is, after the vehicle is determined to be on a lane on a left side of the isolation belt in FIG. 9(c), it may be determined that the speed limit sign at 60 km/h is related to the vehicle, and the speed limit sign at 30 km/h is not related to the vehicle. In this case, the speed limit value of 60 km/h may be selected.

In an embodiment, the vehicle may obtain values of di and dgate, to determine a position of a lane on which the vehicle travels relative to the isolation belt, and then determine whether the speed limit sign and the vehicle are located on a same side of the isolation belt, to determine the correlation between the speed limit sign and the vehicle.

In this embodiment of this application, a plurality of technical solutions for determining a speed limit are proposed based on a main and auxiliary road scenario, so that accuracy of fusion recognition of speed limits of main and auxiliary roads can be improved, and a problem of incorrect speed limit selection in the main and auxiliary road scenario can be resolved.

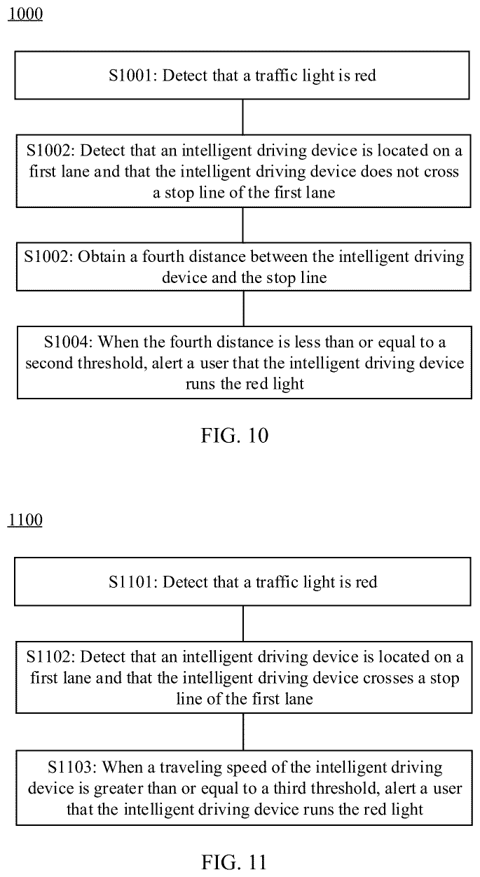

FIG. 10 is a schematic flowchart of another warning method according to an embodiment of this application. An execution body of the method 1000 may be an intelligent driving device. When the execution body of the method 1000 is the intelligent driving device 100, the method 1000 may be performed by a computing platform 130 in the intelligent driving device 100, or may be performed by an SoC in the computing platform 130, or may be performed by a processor in the computing platform 130. The following describes the method 1000 by using the intelligent driving device as the execution body. The method 1000 may include operation S1001 and operation S1004.

S1001: Detect that a traffic light is red.

In an embodiment, a sensor (for example, a camera apparatus) deployed on the intelligent driving device may detect that a traffic light is red.

S1002: Detect that an intelligent driving device is located on a first lane and that the intelligent driving device does not cross a stop line of the first lane.

In an embodiment, road information and position information of the intelligent driving device obtained by a sensor (for example, a camera apparatus) deployed on the intelligent driving device may be used to determine that the intelligent driving device is located on the first lane and that the intelligent driving device does not cross the stop line.

S1003: Obtain a third distance between the intelligent driving device and the stop line.

In an embodiment, the third distance may be a distance between the intelligent driving device and a keypoint of the stop line.

S1004: When the third distance is less than or equal to a second threshold, alert a user that the intelligent driving device runs the red light.

In an embodiment, the second threshold may be a sum of a reaction distance of the user and a braking distance of the intelligent driving device that are obtained by calculating a speed and an acceleration of the intelligent driving device.

For example, when the third distance is 10 meters and the second threshold is 15 meters, the intelligent driving device may alert the user that the intelligent driving device runs a red light.

In an embodiment, the intelligent driving device may display a warning red line on a display to alert the user, and at the same time, the intelligent driving device may emit a prompt tone (for example, a bong sound) to alert the user.

In an embodiment, in operation S1004, before alerting the user that the intelligent driving device runs a red light, the intelligent driving device may determine that the first lane is a straight lane. In this way, the intelligent driving device can be prevented from alerting about running a red light on a turning lane, so that occurrence of a false alarm event is reduced.

In this embodiment of this application, when the intelligent driving device does not cross the stop line, a relationship between the second threshold and the third distance between the intelligent driving device and the stop line is compared, to determine whether to alert the user about running a red light. In this way, a red-light running warning of the intelligent driving device can be more timely and accurate, and occurrence of a false alarm event can be reduced.

FIG. 11 is a schematic flowchart of another warning method according to an embodiment of this application. An execution body of the method 1100 may be an intelligent driving device. When the execution body of the method 1100 is the intelligent driving device 100, the method 1100 may be performed by a computing platform 130 in the intelligent driving device 100, or may be performed by an SoC in the computing platform 130, or may be performed by a processor in the computing platform 130. The following describes the method 1100 by using the intelligent driving device as the execution body. The method 1100 may include operation S1101 and operation S1103.

S1101: Detect that a traffic light is red.

In an embodiment, a sensor (for example, a camera apparatus) deployed on the intelligent driving device may detect that a traffic light is red.

S1102: Detect that an intelligent driving device is located on a first lane and that the intelligent driving device crosses a stop line of the first lane.

In an embodiment, road information and position information of the intelligent driving device obtained by a sensor (for example, a camera apparatus) deployed on the intelligent driving device may be used to determine that the intelligent driving device is located on the first lane and that the intelligent driving device crosses the stop line.

S1103: When a traveling speed of the intelligent driving device is greater than or equal to a third threshold, alert a user that the intelligent driving device runs the red light.

For example, when the traveling speed of the intelligent driving device is 10 km/h, and the third threshold is 0.1 km/h, the intelligent driving device may alert the user that the intelligent driving device runs a red light.

In an embodiment, the intelligent driving device may display a warning red line on a display to alert the user, and the intelligent driving device may emit a prompt tone (for example, a bong sound) to alert the user.

In an embodiment, before alerting the user that the intelligent driving device runs a red light, the intelligent driving device may obtain a fourth distance between the intelligent driving device and the stop line, and determine that the fourth distance is less than or equal to a fourth threshold. In this way, a red-light running warning generated after the intelligent driving device crosses the stop line can be more accurate.

For example, when the fourth distance is 2 meters, and the fourth threshold is 3 meters, the intelligent driving device may alert the user that the intelligent driving device runs a red light.

In this embodiment of this application, when the intelligent driving device crosses the stop line, a relationship between the traveling speed of the intelligent driving device and the third threshold is compared, to determine whether to alert the user about running a red light. In this way, a red-light running warning of the intelligent driving device can be more timely and accurate, so that driving safety of the user is ensured.

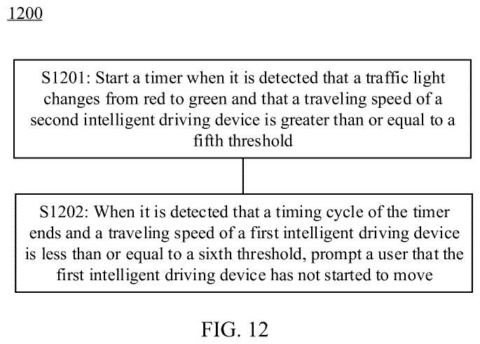

FIG. 12 is a schematic flowchart of another warning method according to an embodiment of this application. An execution body of the method 1200 may be a first intelligent driving device. When the first intelligent driving device is the intelligent driving device 100, the method 1200 may be performed by a computing platform 130 in the intelligent driving device 100, or may be performed by an SoC in the computing platform 130, or may be performed by a processor in the computing platform 130. The following describes the method 1200 by using the first intelligent driving device as the execution body. The method 1200 may include operation S1201 and operation S1202.

S1201: Start a timer when it is detected that a traffic light changes from red to green and that a traveling speed of a second intelligent driving device is greater than or equal to a fifth threshold.

The timer may be located on the first intelligent driving device, both the first intelligent driving device and the second intelligent driving device are located on a first lane, and the second intelligent driving device is located in front of the first intelligent driving device.

In an embodiment, a sensor (for example, a camera apparatus) deployed on the intelligent driving device may detect that a traffic light changes from red to green.

For example, when the traveling speed of the second intelligent driving device is 5.5 km/h, and the fifth threshold is 5.4 km/h, the first intelligent driving device may start the timer.

S1202: When it is detected that a timing cycle of the timer ends and a traveling speed of the first intelligent driving device is less than or equal to a sixth threshold, prompt a user that the first intelligent driving device has not started to move.

For example, when the timing cycle of the timer is 5 seconds, the traveling speed of the first intelligent driving device is 0 km/h, and the sixth threshold is 0.1 km/h, the first intelligent driving device may prompt the user that the first intelligent driving device has not started to move.

In an embodiment, the intelligent driving device may display, on a display, a prompt “Green light available for passage”, and alert the user in a manner of emitting a prompt tone (for example, a bong sound).

It should be understood that the method 1200 may be further applied to a scenario in which there is no second intelligent driving device. For example, when detecting that a traffic light changes from red to green, the first intelligent driving device starts a timer, and when timing of the timer ends and the traveling speed of the first intelligent driving device is less than or equal to the sixth threshold, the first intelligent driving device prompts the user that the first intelligent driving device has not started to move.

In this embodiment of this application, after the traffic light changes from red to green, when the traveling speed of the second intelligent driving device is greater than or equal to the fifth threshold, the first intelligent driving device starts the timer for timing. The first intelligent driving device gives a warning alert to the user only when the first intelligent driving device fails to start to move before a timeout. In this way, an unreasonable warning generated when there is another intelligent driving device in front of the first intelligent driving device can be avoided, so that driving experience of the user is improved.

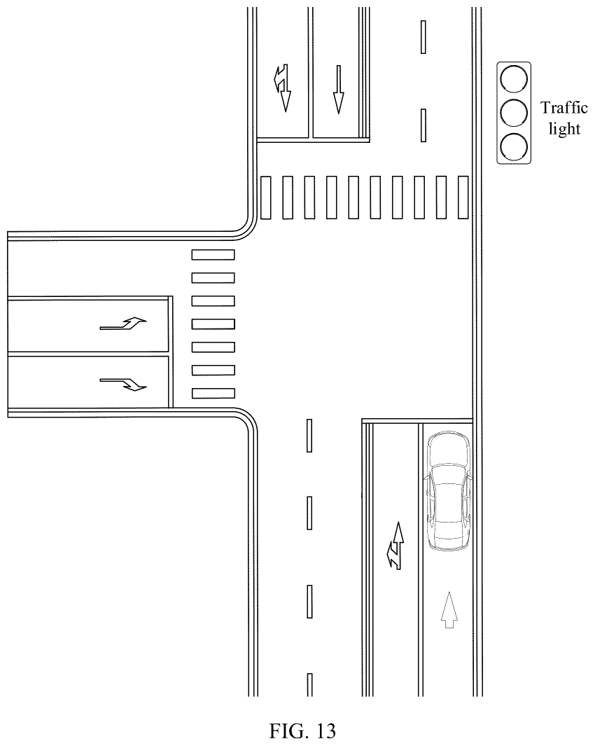

FIG. 13 is a diagram of a red-light running warning scenario based on an unmarked crosswalk of a T-intersection according to an embodiment of this application. This warning scenario may be a scenario to which the method 1000, the method 1100, and the method 1200 are applicable.

As shown in FIG. 13, a distance from the vehicle to a keypoint of a stop line may be calculated, and a reaction distance and a minimum braking distance of a vehicle driven by a driver are calculated based on a current vehicle speed and acceleration of the vehicle driven by the driver. A sum of the two values is an alarm distance. When the vehicle travels straight through an intersection and a traffic light is red, the distance between the vehicle and the stop line may be compared with the alarm distance to determine whether a warning condition is met. The vehicle may be the intelligent driving device in the method 1000, the method 1100, and the method 1200, and the alarm distance may be the second threshold in the method 1000.

For example, if the distance between the vehicle and the stop line is 10 meters and is less than the alarm distance of 15 meters, the vehicle may give a warning alert.

In an embodiment, when the vehicle crosses the stop line and continues to travel, or the vehicle continues to travel after crossing the stop line, and the distance between the vehicle and the stop line is less than a fourth threshold, the vehicle may give a warning alert.

In an embodiment, the method may be used only on a straight lane, to avoid a false alarm when the vehicle turns right at a red light.

Currently, warning effect of a vehicle running a red light is poor, and at an unmarked crosswalk of a T-intersection, the vehicle is prone to detect a marked crosswalk on the other side of the road by mistake, causing a false alarm. In this embodiment of this application, an alarm distance is set, and whether a warning condition is met is determined by comparing the alarm distance with a distance from the vehicle to the stop line, so that a warning scenario of a vehicle running a red light is more timely and accurate, and a false alarm of a vehicle running a red light is reduced.

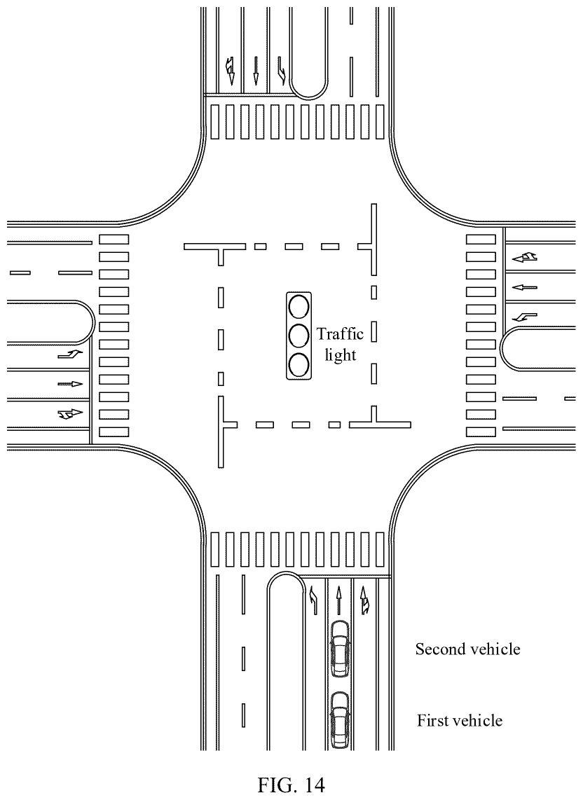

FIG. 14 is a diagram of an application scenario for a vehicle start-to-move alert according to an embodiment of this application. This application scenario may be a scenario to which the method 1200 is applicable.

As shown in FIG. 14, both a first vehicle and a second vehicle are located on a straight lane, and the second vehicle is located in front of the first vehicle. When the first vehicle is stationary at an intersection of the straight lane waiting for passage, after a traffic light in front changes from red to green, the first vehicle starts timing after the second vehicle has started. If the first vehicle fails to start to move before a timeout, the first vehicle may emit a prompt “Green light available for passage” to a user. The first vehicle may be the first intelligent driving device in the method 1200, and the second vehicle may be the second intelligent driving device in the method 1200.

In a current application scenario of the vehicle start-to-move alert, if there is a second vehicle in front of the first vehicle, the first vehicle may give a start-to-move warning alert when the first vehicle has not started. Such a warning is unreasonable, and driving experience of the user is severely affected. In this embodiment of this application, after the traffic light changes from red to green, the first vehicle starts timing, and the first vehicle gives a warning alert to the user only when the first vehicle fails to start to move before a timeout. In this way, an unreasonable warning generated when there is a vehicle in front of the first vehicle can be avoided, so that driving experience of the user is improved.

It should be understood that in embodiments of this application, unless otherwise stated or there is a logic conflict, terms and/or descriptions in all embodiments are consistent and may be mutually referenced, and technical features in different embodiments may be combined based on an internal logical relationship thereof, to form a new embodiment.

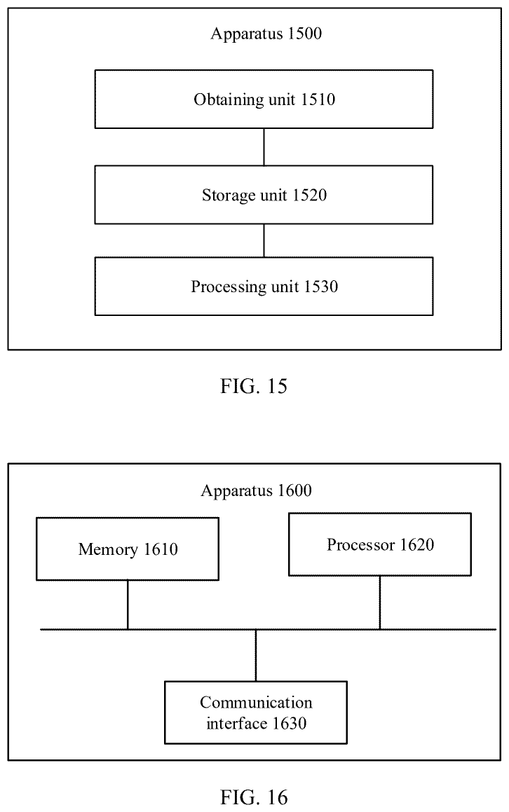

FIG. 15 is a diagram of a warning apparatus 1500 according to an embodiment of this application. The apparatus 1500 may include an obtaining unit 1510, a storage unit 1520, and a processing unit 1530. The obtaining unit 1510 is configured to obtain instructions and/or data. The obtaining unit 1510 may alternatively be referred to as a communication interface or a communication unit. The storage unit 1520 is configured to implement a corresponding storage function, and store corresponding instructions and/or data. The processing unit 1530 is configured to perform data processing. The processing unit 1530 may read instructions and/or data in the storage unit 1520, so that the apparatus 1500 implements the foregoing warning method.

In a design, the apparatus 1500 includes an obtaining unit 1510 and a processing unit 1530. The obtaining unit 1510 is configured to obtain information about a speed limit sign. The information about the speed limit sign indicates that the speed limit sign is a ramp speed limit sign or an auxiliary road speed limit sign. The processing unit 1530 is configured to determine, based on road information of a first lane on which an intelligent driving device is located and the information about the speed limit sign, whether to alert a user to a speed limit value corresponding to the speed limit sign. The road information of the first lane indicates that the first lane is a main road, a ramp, or an auxiliary road.

In an embodiment, the obtaining unit 1510 is further configured to obtain a position of the speed limit sign and a feature of the speed limit sign. The feature of the speed limit sign includes at least one of the following: text, a pattern, and a background color of the speed limit sign. The processing unit 1530 is further configured to determine the information about the speed limit sign based on the position of the speed limit sign and the feature of the speed limit sign.

In an embodiment, the obtaining unit 1510 is further configured to obtain a position of the speed limit sign and a position of a road split point. The processing unit 1530 is further configured to determine the information about the speed limit sign based on the position of the speed limit sign and the position of the road split point.

In an embodiment, the obtaining unit 1510 is further configured to obtain position information of the intelligent driving device and map speed limit information. The map speed limit information indicates a speed limit value of the first lane identified on a map. The processing unit 1530 is further configured to: determine, based on the position information of the intelligent driving device and the map speed limit information, that the first lane is a ramp or an auxiliary road; determine, based on the road information of the first lane and the information about the speed limit sign, that the first lane is associated with the speed limit sign; and alert the user to the speed limit value corresponding to the speed limit sign.

In an embodiment, the obtaining unit 1510 is further configured to obtain position information of the intelligent driving device. The processing unit 1530 is further configured to: determine, based on the position information of the intelligent driving device, the position of the speed limit sign, and the position of the road split point, that the first lane is a ramp or an auxiliary road. The determining, based on road information of a first lane on which an intelligent driving device is located and the information about the speed limit sign, whether to alert a user to a speed limit value of the speed limit sign includes: determining, based on the road information of the first lane and the information about the speed limit sign, that the first lane is associated with the speed limit sign; and alerting the user to the speed limit value corresponding to the speed limit sign.

In an embodiment, the obtaining unit 1510 is further configured to obtain a first distance and a second distance. The first distance is a distance between the first lane and a second lane, the second distance is a distance between the second lane and a third lane, the second lane is adjacent to the first lane, and the second lane is adjacent to the third lane. The processing unit 1530 is further configured to: when a difference between the first distance and the second distance is greater than a first threshold, determine that the speed limit sign is a ramp speed limit sign or an auxiliary road speed limit sign.

In an embodiment, the first lane and the second lane are of different road types, and there is an isolation belt between the first lane and the second lane. The obtaining unit 1510 is further configured to obtain a position of the speed limit sign. The processing unit 1530 is further configured to: determine a position of the first lane relative to the isolation belt based on the first distance and the second distance; determine, based on the position of the speed limit sign and the position of the first lane relative to the isolation belt, whether the speed limit sign is associated with the first lane; and when the speed limit sign is associated with the first lane and the road information of the first lane matches the information about the speed limit sign, alert the user to the speed limit value corresponding to the speed limit sign.

In another design, the apparatus 1500 includes an obtaining unit 1510 and a processing unit 1530. The processing unit 1530 is configured to: detect that a traffic light is red; and detect that an intelligent driving device is located on a first lane and that the intelligent driving device does not cross a stop line of the first lane. The obtaining unit 1510 is configured to obtain a third distance between the intelligent driving device and the stop line. The processing unit 1530 is further configured to: when the third distance is less than or equal to a second threshold, alert a user that the intelligent driving device runs a red light.

In an embodiment, the processing unit 1530 is further configured to detect that the first lane is a straight lane.

In another design, the apparatus 1500 includes a processing unit 1530. The processing unit 1530 is configured to: detect that a traffic light is red; detect that an intelligent driving device is located on a first lane and that the intelligent driving device crosses a stop line of the first lane; and when a traveling speed of the intelligent driving device is greater than or equal to a third threshold, alert a user that the intelligent driving device runs a red light.

In an embodiment, the apparatus 1500 further includes an obtaining unit 1510. The obtaining unit 1510 is configured to obtain a fourth distance between the intelligent driving device and the stop line. The processing unit 1530 is further configured to determine that the fourth distance is less than or equal to a fourth threshold.

In another design, the apparatus 1500 is applied to a first intelligent driving device, the first intelligent driving device is located on a first lane, and the apparatus 1500 includes a processing unit 1530. The processing unit 1530 is configured to: start a timer when detecting that a traffic light changes from red to green and that a traveling speed of a second intelligent driving device is greater than or equal to a fifth threshold, where the timer is located on the first intelligent driving device, the second intelligent driving device is located on the first lane, and the second intelligent driving device is located in front of the first intelligent driving device; and when detecting that a timing cycle of the timer ends and a traveling speed of the first intelligent driving device is less than or equal to a sixth threshold, prompt a user that the first intelligent driving device is not started.

In an embodiment, if the apparatus 1500 is located in the intelligent driving device 100, the processing unit 1530 may be the processor 131 shown in FIG. 1.

FIG. 16 is a diagram of another warning apparatus 1600 according to an embodiment of this application.

The apparatus 1600 includes a memory 1610, a processor 1620, and a communication interface 1630. The memory 1610, the processor 1620, and the communication interface 1630 are connected through an internal connection path. The memory 1610 is configured to store instructions. The processor 1620 is configured to execute the instructions stored in the memory 1610, to control the communication interface 1630 to obtain information, so that the apparatus 1600 implements the foregoing warning method. In an embodiment, the memory 1610 may be coupled to the processor 1620 through an interface, or may be integrated with the processor 1620.

It should be noted that the communication interface 1630 uses a transceiver apparatus, for example, but not limited to, a transceiver. The communication interface 1630 may further include an input/output interface.

The processor 1620 stores one or more computer programs, and the one or more computer programs include instructions. When the instructions are run by the processor 1620, the warning apparatus 1600 is enabled to perform the warning method in the foregoing embodiments.

In an embodiment, the operations in the foregoing method can be implemented by using an integrated logic circuit of hardware in the processor 1620, or by using instructions in a form of software. The method disclosed with reference to embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory 1610, and the processor 1620 reads information in the memory 1610 and completes the operations in the foregoing method in combination with hardware in the processor 1620. To avoid repetition, details are not described herein again.

In an embodiment, the communication interface 1630 in FIG. 16 may implement the obtaining unit 1510 in FIG. 15, the memory 1610 in FIG. 16 may implement the storage unit 1520 in FIG. 15, and the processor 1620 in FIG. 16 may implement the processing unit 1530 in FIG. 15.

In an embodiment, the apparatus 1500 or the apparatus 1600 may be located in the intelligent driving device 100 in FIG. 1.

In an embodiment, the apparatus 1500 or the apparatus 1600 may be the computing platform 130 in the intelligent driving device in FIG. 1.

An embodiment of this application further provides a computer-readable storage medium, where the computer-readable storage medium stores program code, and when the computer program code is run on a computer, the computer is enabled to perform any method in FIG. 3 to FIG. 14.

An embodiment of this application further provides a computer program product, where the computer product includes a computer program, and when the computer program is run, a computer is enabled to perform any method in FIG. 3 to FIG. 14.

An embodiment of this application further provides a chip, including a circuit, where the circuit is configured to perform any method in FIG. 2 to FIG. 14.

An embodiment of this application further provides an intelligent driving device, including any warning apparatus shown in FIG. 15 or FIG. 16.

A person of ordinary skill in the art may be aware that, in combination with the examples described in embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application while remaining within the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus and method may be implemented in other manners. For example, the described apparatus embodiment is merely an example. For example, division into the units is merely logical function division and may be implemented using other division. For example, a plurality of units or components may be combined or integrated into another system, or some features may be ignored or not performed. In addition, the mutual coupling or direct coupling or communication connection shown or discussed may be indirect coupling or communication connection through some interfaces, apparatuses, or units, and may be in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the operations of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are describe various embodiments of this application, but are not intended to limit the protective scope of this application. Any variation or replacement readily figured out by a person skilled in the art within the technical scope disclosed in this application shall fall within the protective scope of this application. The protective scope of this application shall be subject to the scope of the claims.

1. A method, comprising:
obtaining, with a sensor of an intelligent driving device, information about a speed limit sign, wherein the information about the speed limit sign indicates that the speed limit sign is a ramp speed limit sign or an auxiliary road speed limit sign;
determining, based on road information of a first lane on which the intelligent driving device is located and the information about the speed limit sign, whether to alert a user to a speed limit value corresponding to the speed limit sign, wherein the road information of the first lane indicates that the first lane is a main road, a ramp, or an auxiliary road; and
alerting the user to the speed limit value corresponding to the speed limit sign.

2. The method according to claim 1, wherein the obtaining information about the speed limit sign comprises:
obtaining, with the sensor, a position of the speed limit sign and a feature of the speed limit sign, wherein the feature of the speed limit sign comprises at least one of the following: text, a pattern, or a background color of the speed limit sign; and
determining the information about the speed limit sign based on the position of the speed limit sign and the feature of the speed limit sign.

3. The method according to claim 1, wherein the obtaining information about the speed limit sign comprises:
obtaining a position of the speed limit sign and a position of a road split point; and
determining the information about the speed limit sign based on the position of the speed limit sign and the position of the road split point.

4. The method according to claim 1, wherein before the determining whether to alert the user to the speed limit value corresponding to the speed limit sign, the method further comprises:
obtaining position information of the intelligent driving device and map speed limit information, wherein the map speed limit information indicates a speed limit value of the first lane identified on a map; and
determining, based on the position information of the intelligent driving device and the map speed limit information, that the first lane is a ramp or an auxiliary road; and
the determining whether to alert the user to the speed limit value of the speed limit sign comprises:
determining, based on the road information of the first lane and the information about the speed limit sign, that the first lane is associated with the speed limit sign,
wherein the alerting the user to the speed limit value corresponding to the speed limit sign is performed in accordance with when the first lane is associated with the speed limit sign.

5. The method according to claim 3, wherein before the determining; whether to alert the user to the speed limit value corresponding to the speed limit sign, the method further comprises:
obtaining position information of the intelligent driving device;
determining, based on the position information of the intelligent driving device, the position of the speed limit sign, and the position of the road split point, that the first lane is a ramp or an auxiliary road, wherein
the determining whether to alert the user to the speed limit value of the speed limit sign comprises:
determining, based on the road information of the first lane and the information about the speed limit sign, that the first lane is associated with the speed limit sign,
wherein the alerting the user to the speed limit value corresponding to the speed limit sign is performed in accordance with when the first lane is associated with the speed limit sign.

6. The method according to claim 1, wherein the obtaining information about the speed limit sign comprises:
obtaining a first distance between the first lane and a second lane;
obtaining a, second distance between the second lane and a third lane, the second lane being adjacent to the first lane and to the third lane; and
when a difference between the first distance and the second distance is greater than a first threshold, determining that the speed limit sign is a ramp speed limit sign or an auxiliary road speed limit sign.

7. The method according to claim 6, wherein the first lane and the second lane are of different road types, and an isolation belt is located between the first lane and the second lane; and
the determining whether to alert the user to the speed limit value corresponding to the speed limit sign comprises:
obtaining a position of the speed limit sign;
determining a position of the first lane relative to the isolation belt based on the first distance and the second distance;
determining, based on the position of the speed limit sign and the position of the first lane relative to the isolation belt, whether the speed limit sign is associated with the first lane,
wherein the alerting the user to the speed limit value corresponding to the speed limit sign is performed in accordance with when the speed limit sign is associated with the first lane and the road information of the first lane matches the information about the speed limit sign.

8. The method according to claim 1, wherein the method comprises:
detecting that a traffic light is red;
detecting that the intelligent driving device is located on a second lane and that the intelligent driving device does not cross a stop line of the second lane;
obtaining a third distance between the intelligent driving device and the stop line; and
when the third distance is less than or equal to a second threshold, alerting a the user that the intelligent driving device runs a red light.

9. The method according to claim 8, further comprising:
detecting that the second lane is a straight lane prior to alerting the user that the intelligent driving device runs the red light.

10. The method according to claim 1, wherein the method comprises:
detecting that a traffic light is red;
detecting that the intelligent driving device is located on a third lane and that the intelligent driving device crosses a stop line of the third lane; and
when a traveling speed of the intelligent driving device is greater than or equal to a third threshold, alerting the user that the intelligent driving device runs a red light.

11. The method according to claim 10, further comprising:
prior to alerting the user that the intelligent driving device runs the red light, obtaining a fourth distance between the intelligent driving device and the stop line; and
determining that the fourth distance is less than or equal to a fourth threshold.

12. The method according to claim 1, wherein the method comprises:
starting a timer when detecting that the traffic light changes from red to green and that a traveling speed of a second intelligent driving device that is located on the first lane in front of the intelligent driving device is greater than or equal to a fifth threshold, wherein the timer is located on the intelligent driving device; and
when the timer ends and a traveling speed of the intelligent driving device is less than or equal to a sixth threshold, prompting the user that the intelligent driving device has not moved.

13. An apparatus, comprising:
at least one processor; and
a memory coupled to the at least one processor and storing programming instructions, which when executed by the at least one processor, cause the apparatus to:
obtain, by the at least one processor with a sensor of an intelligent driving device, information about a speed limit sign, wherein the information about the speed limit sign indicates that the speed limit sign is a ramp speed limit sign or an auxiliary road speed limit sign;
determine, based on road information of a first lane on which the intelligent driving device is located and the information about the speed limit sign, whether to alert a user to a speed limit value corresponding to the speed limit sign, wherein the road information of the first lane indicates that the first lane is a main road, a ramp, or an auxiliary road; and
alert the user to the speed limit value corresponding to the speed limit sign.

14. The apparatus according to claim 13, wherein the at least one processor is further caused to:
obtain, with the sensor, a position of the speed limit sign and a feature of the speed limit sign, wherein the feature of the speed limit sign comprises at least one of the following: text, a pattern, and or a background color of the speed limit sign; and
determine the information about the speed limit sign based on the position of the speed limit sign and the feature of the speed limit sign.

15. The apparatus according to claim 13, wherein the at least one processor is further caused to:
obtain a position of the speed limit sign and a position of a road split point; and
determine the information about the speed limit sign based on the position of the speed limit sign and the position of the road split point.

16. The apparatus according to claim 13, wherein the at least one processor is further caused to:
obtain position information of the intelligent driving device and map speed limit information, wherein the map speed limit information indicates a speed limit value of the first lane identified on a map; and
determine, based on the position information of the intelligent driving device and the map speed limit information, that the first lane is a ramp or an auxiliary road,
wherein to determine whether to alert the user to the speed limit value of the speed limit sign comprises to:
determine, based on the road information of the first lane and the information about the speed limit sign, that the first lane is associated with the speed limit sign,
wherein to alert the user to the speed limit value corresponding to the speed limit sign is performed in accordance with when the first lane is associated with the speed limit sign.

17. The apparatus according to claim 15, wherein the at least one processor is further caused to:
obtain position information of the intelligent driving device; and
determine, based on the position information of the intelligent driving device, the position of the speed limit sign, and the position of the road split point, that the first lane is a ramp or an auxiliary road,
wherein to determine whether to alert the user to the speed limit value of the speed limit sign comprises to:
determine, based on the road information of the first lane and the information about the speed limit sign, that the first lane is associated with the speed limit sign,
wherein to alert the user to the speed limit value corresponding to the speed limit sign is performed in accordance with when the first lane is associated with the speed limit sign.

18. The apparatus according to claim 13, wherein the at least one processor is further caused to:
obtain a first distance between the first lane and a second lane;
obtain, a second distance between the second lane and a third lane, the second lane being adjacent to the first lane and adjacent to the third lane; and
when a difference between the first distance and the second distance is greater than a first threshold, determine that the speed limit sign is a ramp speed limit sign or an auxiliary road speed limit sign.

19. The apparatus according to claim 18, wherein the first lane and the second lane are of different road types, and an isolation belt is located between the first lane and the second lane,
and to determine whether to alert the user to the speed limit value comprises to: obtain a position of the speed limit sign,
determine a position of the first lane relative to the isolation belt based on the first distance and the second distance,
determine, based on the position of the speed limit sign and the position of the first lane relative to the isolation belt, whether the speed limit sign is associated with the first lane, and
wherein to alert the user to the speed limit value corresponding to the speed limit sign is performed in accordance with when the speed limit sign is associated with the first lane and the road information of the first lane matches the information about the speed limit sign.

20. A non-transitory storage medium storing a program, which when executed by one or more processors, enables the one or more processors to:
obtain, by the one or more processors with a sensor of an intelligent driving device, information about a speed limit sign, wherein the information about the speed limit sign indicates that the speed limit sign is a ramp speed limit sign or an auxiliary road speed limit sign;
determine, based on road information of a first lane on which an intelligent driving device is located and the information about the speed limit sign, whether to alert a user to a speed limit value corresponding to the speed limit sign, wherein the road information of the first lane indicates that the first lane is a main road, a ramp, or an auxiliary road; and
alert the user to the speed limit value corresponding to the speed limit sign.
